(19) United States
(12) Patent Application Publication
(10) Pub. No.: US 2003/0075828 A1
(43) Pub. Date: Apr. 24, 2003

(54) Solvent resistant glove

(76) Inventors: Jonathan David Thomas, Cambridgeshire (GB); Angela Bryant, Cambridge (GB)

Correspondence Address: STEVENS DAVIS MILLER & MOSHER, LLP, 1615 L STREET, NW, SUITE 850, WASHINGTON, DC, 20036, US

(21) Appl. No.: 10/209,639

(22) Filed: Aug. 1, 2002

Related U.S. Application Data
(63) Continuation-in-part of application No. 09/720,674, filed on Apr. 9, 2001, now abandoned.
Application No. 09/720,674 is a 371 of international application No. PCT/GB99/02667, filed on Aug. 13, 1998.

(30) Foreign Application Priority Data
Aug. 13, 1998 (GB) 9817702.5

(51) Int. Cl. B28B 1/14; B28B 3/10

(52) U.S. Cl. 264/308

(57) ABSTRACT

A thin flexible solvent-resistant glove has a solvent-resistant layer comprising a fluoroelasomer, the layer having been formed from an aqueous dispersion of the fluoroelastomer. The dispersion can also contain a small amount of fluoroplastic.

This application is a continuation-in-part of U.S. application Ser. No. 09/720,674, filed Apr. 9, 2001, which is an application under 35 USC § 371 of PCT/GB/99/02667, filed Aug. 13, 1998, both of which are herein incorporated by reference in their entireties.

### BACKGROUND OF THE INVENTION

This invention relates to a process for making a solvent-resistant glove.

A range of solvent-resistant gloves is available, although the protection afforded against solvents varies markedly within the range. Gloves at one end of the range are inexpensive and comparatively easy to make but they typically offer protection against only one or two solvents. Those at the other end of the range offer protection against a much broader range of solvents. Such solvents include halogenated aliphatic and aromatic solvents, particularly those that are fluorinated or chlorinated; ketones; and aqueous acids and alkalis. Examples of gloves offering broad protection include those made from laminated films and those made from thick butyl rubber. Whilst offering good protection, however, many of these types of gloves are-difficult to wear and unsuitable for fine manipulations within a laboratory setting.

It is known to improve the solvent resistance of a glove by coating an elastomeric substrate with a fluorinated elastomer such as Viton (trademark). Viton is a copolymer of hexafluoropropylene and vinylidene fluoride. Typically the elastomeric substrate is butyl rubber. The fluorinated elastomer layer is formed first by dipping a former into a solution of the fluorinated elastomer in an organic solvent, and the substrate layer is formed thereover by dipping. Ketones are commonly used as the solvent for the fluorinated elastomer. Whilst it is possible by this process to make satisfactory gloves, the necessity to use organic solvents is a serious disadvantage because of the health, safety and environmental risks associated therewith. Furthermore, it is usually necessary to alter the solvent system with every change in substrate and/or fluorinated elastomer, to avoid interference by the solvent on either layer. This adds to the cost of this technique and is generally undesirable.

We have now discovered a process for making a glove comprising an elastomeric substrate and a fluorinated elastomeric coating, in which process it is not necessary to use organic solvents. In particular, we have found that the fluorinated elastomeric coating can be deposited from an aqueous dispersion. This avoids the use of costly organic solvents, provides a much safer manufacturing process, and obviates the need for solvent disposal or recovery.

In one aspect, the present invention provides a process for making a thin, flexible glove comprising a substrate layer and a thin solvent-resistant layer comprising a fluorinated elastomer, wherein said solvent-resistant layer is formed from an aqueous dispersion of a fluorinated elastomer, and wherein the aqueous dispersion also contains a fluoroplastic in an amount less than 10% by solids weight of the dispersion.

The invention also includes a glove made by the above process.

We have found that the solvent resistance of the fluorinated elastomer layer is improved by including in the aqueous dispersion a small amount of a fluoroplastic resin such as polytetrafluoroethylene. By small amount, we mean preferably around 5% (by solids weight of the dispersion) although greater or less amounts can be used. The maximum amount should be less than 10%.

EP-A-0159268 describes modifying a fluoroplastic resin dispersion by including therein a fluoroelastomer latex in an amount from 5% to 90%, in order to reduce the tendency of coatings formed therefrom to crack. Whilst the specification refers to the possibility of making gloves, it is primarily concerned with coating fabrics and the lowest preparation of fluoroplastic exemplified is 50%. We have found that gloves made from such mixtures are not usefully solvent resistant.

### SUMMARY OF THE INVENTION

The gloves of the invention are preferably close fitting thin elastomeric gloves especially suitable for use in laboratories or the like. The fluoroelastomer layer will normally be about 50 μm thick (and not usually greater than 100 μm) and the thickness of the glove wall (i.e., substrate and fluoroelastomer coating) about 0.4 mm.

The gloves of the present invention are normally two-layer gloves, comprising a substrate coated on its external surface with a layer comprising a fluorinated elastomer. However, three-layer gloves are possible, comprising a substrate layer, a fluorinated elastomer layer and then another layer of substrate, the fluorinated elastomer being sandwiched between the two substrate layers.

The substrate is preferably elastomeric in which case any elastomer can be used which is suitable for glove making and to which the fluoroelastomer can bond. The substrate material should preferably have a low modulus such that the stress at 100% strain (S100%) does not exceed 5 MPa. Suitable elastomeric substrate materials include, for example, butyl rubber, nitrile rubber, polychloroprene rubber, blends of nitrile rubber and polychloroprene, natural rubber, synthetic polyisoprene rubber, polyurethanes and combinations of any two or more of the above.

We prefer to use a ‘soft’ nitrile rubber such as one consisting of carboxylated acrylonitrile-butadiene of relatively low acrylonitrile content. Examples of such soft rubbers are Synthomer 6000 (composition by percentage weight: butadiene 70, acrylonitrile 26, methacrylic acid 4; Synthomer Ltd. of Grimsby) and 70:30 blend of Synthomer 6000 and Neoprene 750 (trademark of a polychloroprene rubber) which blend is available as Synthomer 6510 (Synthomer Ltd. of Grimsby)

We prefer to provide the substrate layer(s) by dipping a glove-shaped former into an aqueous dispersion of the substrate elastomer. Such dispersions will also normally contain other components such as fillers, crosslinking agents and accelerators, as will be clear to those skilled in the art. Generally, the dispersion will contain:

| | Parts by wt (dry) |
|---|---|
| Elastomer | 100 |
| Crosslinking agent | 0.5-5.0 |
| Viscosity modifier | 0.2-2.0 |
| Acid scavenger | 0-30 |
| Water | to provide 30-50% total solids |

Whilst gloves of the present invention will most usually comprise an elastomeric substrate, they can alternatively have a non-elastomeric substrate such as a woven material, e.g., a cotton liner.

The layer of the fluoroelastomer is preferably formed by dipping a former (optionally bearing the substrate layer) into an aqueous dispersion of the fluoroelastomer. Generally, the dispersion will also contain other materials such as a crosslinking agent, a viscosity modifier and an acid scavenger.

### BRIEF DESCRIPTION OF THE DRAWING

FIG. 1 shows a glove in accordance with the invention.

### DETAILED DESCRIPTION OF THE INVENTION

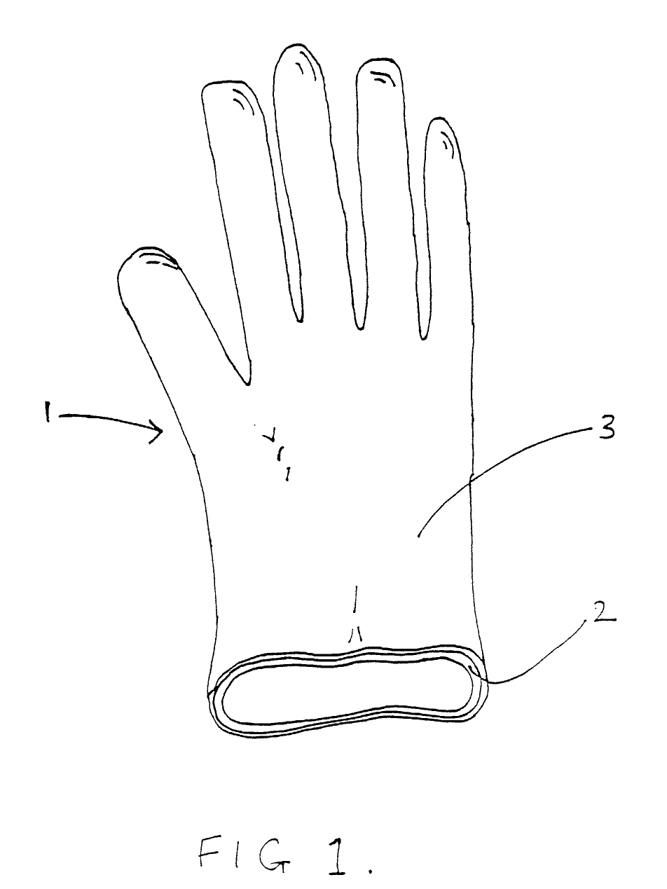

A glove 1, formed in accordance with the present invention, is shown in FIG. 1. Glove 1 includes a substrate layer 2 inside a solvent-resistant layer 3.

Any fluoroelastomer can be used which is sufficiently elastic to deform with the substrate layer without separating or cracking and which can be provided as an aqueouss dispersion suitable for dipping. The fluoroelastomer should form a suitable layer on the glove former (or on the substrate layer).

Such fluoroelastomers may be obtained by copolymerisation of vinylidene fluoride (1,1-difluoroethylene) with one or more comonomers selected from chlorotrifluoroethylene, hexafluoropropylene, 1-hydropentafluoropropylene, perfluoro(methyl vinyl ether), and tetrafluoroethylene. Copolymers of vinylidene fluoride with hexafluoropropylene and tetrafluoroethylene are preferred.

The intended function of the fluoroelastomer layer is to provide solvent resistance, so fluoroelastomers that have good qualities consistent therewith are to be preferred. Since solvent resistance generally increases with the fluorine content of the polymer, a high degree of fluorination is preferred, for example, 65 to 71 weight per cent fluorine; more preferably, 67 to 71 weight per cent fluorine.

As previously stated, we have found that solvent resistance can be increased by mixing a small amount of a fluoroplastic with the fluorinated elastomer. The term “fluoroplastic” is to be understood to encompass both hydrogen-containing fluoroplastics and hydrogen-free perfluoroplastics. Fluoroplastic polymers are thus those which have some or all of the hydrogen replaced by fluorine. The preferred fluoroplastic is polytetrafluoroethylene, but other fluoroplastics may also be used such as fluorinated ethylene propylene (FEP) copolymer, perfluoroalkoxy (PFA) resin, chlorotrifluoroethylene and copolymers thereof with vinylene fluoride, ethylene-chloro-trifluoroethylene (ECTFE) copolymer, ethylenetetrafluoroethylene (ETFE) copolymer, polyvinylidene fluoride (PVDF), and polyvinylfluoride.

A particularly preferred aqueous dispersion of a fluoroelastomer is commercially available under the trade name Fluorobase T300 (from Ausimont UK of Putney). This is a high-solids (65-70 wt %) dispersion of an emulsion copolymer of vinylidene fluoride, hexafluoropropylene, and tetrafluoroethylene, blended with about 5% of a polytetrafluoroethylene dispersion. It has a fluorine content of 67-69 wt %. In order to achieve the high solids content, a suitable surfactant is employed to obtain a high concentration of monomers in emulsion prior to polymerisation.

A crosslinking agent is usually included to covalently crosslink the fluoroelastomer so as to improve the tensile strength of the glove. Suitable crosslinkers include water-soluble or dispersible diamines; bisphenols, such as bisphenol A and bisphenol AF; and organic peroxides. A preferred crosslinker is Fluorobase T520 (ex-Ausirnont) which is 1,4-bis(3-aminopropyl)piperazine.

A viscosity modifier is optional. It is preferably included in the aqueous dispersion because it can assist the formation of the fluoroelastomer film on the elastomeric substrate and can exert control over its thickness. One suitable viscosity modifier is Carbopol Aqua 30 (B.F. Goodrich) which is an acrylic thickener supplied as a 30% solution. It is diluted for use as a 2.6% solution in water. We typically use about 0.23 phr with respect to flaoroelastomer content (which is about 0.006 parts dry weight). Other viscosity modifiers that can be used, but are less preferred, include polysaccharide gums, polyvinyl alcohols and clays. The quantity of modifier to be used will depend on its nature and on the desired viscosity, which will depend, in turn, on the thickness of fluoroelastomer film required. For the Mowiol 18-88 modifier, it was found that a 33 seconds B3 flow cup viscosity was desirable to obtain a fluoroelastomer film thickness of 50 microns.

An acid ‘scavenger’ is included in the dispersion to react with any hydrogen fluoride generated during the cross linking reaction. Preferred scavengers are metal oxides, particularly zinc oxide, magnesium oxide, and calcium hydroxide. Antiwebbing agents and other additives may also be included as will be clear to those skilled in the art.

In general the aqueous despersion of fluoroelastomer will comprise:

| | Parts by wt (dry) | Preferred range |
|---|---|---|
| Fluoroelastomer | 100 | 100 |
| Crosslinker | 0.1-5.0 | 0.2-3.0 |
| Acid Scavenger | 1-15 | 2-15 |
| Viscosity modifier (for 33s B3 flow | .005+ | .005+ |
| cup viscosity) | | |
| Water to solids content of (wt %) | 64 | 62-65 |

One preferred formulation is:

| | Parts by wt (dry) |
|---|---|
| 67% Fluorobase T300 dispersion | 100 |
| 50% Fluorobase T520 solution | 1 |
| Zinc oxide | 5 |
| Carbopol Aqua 30 | to 33s B3 flow cup viscosity |

If desired, the formulation may also contain a coloured pigment. Suitable pigments include Unisperse Red FBN-P1 (Ciba), Unisperse Violet BE (Ciba) and Colanyl Blue (Hoechst).

The gloves of the invention are preferably made by dipping. By way of example, the following stepwise procedure can be used to make a glove comprising an inner layer of elastomeric substrate and an outer layer of fluoroelastomer.

1. Preheat former for example to 60 to 80° C., preferably about 70° C.

2. Dip former in a coagulant, such as a 20% aqueous solution of calcium nitrate.

3. Dry the former.

4. Dip former into aqueous dispersion of the elastomeric substrate material.

5. Dry the coated former e.g. at 110° C., for example for about 20 minutes.

6. Leach in water to remove coagulant, e.g. at about 65° C. for about 5 minutes.

7. Dry, e.g. at 120° C. until film temperature is 90-100° C.

8. Dip the coated former into an aqueous dispersion containing fluoroelastomer.

9. Dry, e.g. at 110-125° C. for 20 minutes.

In stages 4 and 8, a single dip is preferred. Repeated dipping leads to thicker layers of substrate and/or fluoroelastomer and this can be employed if necessary. The above process is preferably used to form a glove whose overall thickness (across one wall) is not more than 0.25 mm but it can be used for gloves up to about 0.4 mm thickness. The fluoroelastomer layer can be up to 100 μm thick but is preferably about 50 μm thick. This results in a thin, highly usable glove that is comfortable to wear and offers superior solvent-resistance over existing gloves of corresponding thickness. Depending on the choice of materials, the glove can be effective against aromatic and halogenated solvents, and, in particular, can show good resistance to toluene and xylene. The glove can be produced either in ambidextrous or in handed form, with or without a grip pattern.

Alternatively, it is possible to coat the former with mould release agent and then to dip first into the fluoroelastomer (step 8 above) and then follow with steps 9 and 6 and then, after drying, to follow step 2 (but with an alcoholic solution of calcium nitrate) and through to step 5. Suitable mould release agents are those based upon fluorocarbon polymers sold under the tradename McLube (manufactured by Loctréc AB).

In another procedure, heat sensitised latices can be used (by addition of polyvinyl methyl ether or Coagulant WS (Bayer) for example, to avoid the coagulant dip steps.

The process of the present invention can also be used to make a glove wherein a fluoroelastomeric layer is sandwiched between two layers of elastomeric substrate. This results in a thicker glove that is particularly suitable for industrial use. We prefer to make this a handed glove incorporating a grip pattern. This type of glove is intended to be used for heavier tasks requiring more physical protection and so the elastomeric substrate material will be chosen accordingly. We prefer to use a blend of Perbunan N latex VT (composition by percentage weight: butadiene 66, acrylonitrile 30, methacrylic acid 4; Bayer) and Synthomer 99G43 (a high acrylonitrile nitrile latex with composition by percentage weight: butadiene 55, acrylonitrile 39, methacrylic acid 6). Other latices displaying similar physical properties to the above blend can also be used; for example, blends of Synthomer 99G43 with Perbunan N latex T (composition by percentage weight: butadiene 63, acrylonitrile 35, methacrylic acid 2; Bayer) or with Perbunan N latex 3415M (composition by percentage weight: butadiene 63, acrylonitrile 33, methacrylic acid 4; Bayer).

An aqueous dispersion of fluorinated elastomer as previously described is employed to provide the fluoroelastomer layer in this three-layer glove.

One example of a process for making the three-layer glove comprises steps 1-9 outlined above for the thin, laboratory-use glove and the following additional steps:

10. Cool dip in coagulant (e.g. 20% alcoholic solution of calcium nitrate).

11. Dip into aqueous dispersion of elastomeric substrate material.

12. Dry, e.g. at 110-125° C. for 20 minutes.

Again, single dips are preferred but more than one can be used if necessary. This process is very suitable for making an industrial-use glove with a single wall thickness of no more than about 0.4 mm. The fluoroelastomer layer is preferably 50 μm thick but can be as thick as 100 μm.

In order that the invention may be more fully understood, the following Examples are given by way of illustration only.

### EXAMPLE 1

A glove-shaped former was heated to 70° C. and then dipped in a 20% aqueous solution of calcium nitrate. The former was dried at 7° C. for 1 minute and then dipped for 5 seconds into a compounded Synthomer 6000 dispersion.

The coated former was dried at 110° C. for 20 minutes and then washed in water at a temperature of 65° C. for 5 minutes to remove excess coagulant. The former was dried at 120° C. until the layer of coagulated substrate was at a temperature of 100° C. The former was then dipped for 10 seconds into an aqueous dispersion of fluoroelastomer, which dispersion had the following composition:

| | Parts by weight (dry) |
|---|---|
| 67% Fluorobase T300 dispersion | 100 |
| 50% Fluorobase T520 solution | 1 |
| Zinc oxide | 5 |
| Carbopol Aqua 30 | To 33s B3 3 viscosity |

The formulation of a suitable aqueous zinc oxide dispersion will be well known to those skilled in the art.

The former was then heated at 115° C. for 20 minutes to dry and crosslink the fluoroelastomer and complete vulcanisation of the rubber. The finished glove was dusted with talc and then stripped from the former. This glove had a single wall thickness of about 250 μm.

### EXAMPLE 2

A glove was made according to the procedure described in Example 1 except that the substrate layer was formed from a compounded Synthomer 6510 dispersion.

This glove had the following physical characteristics:

| Thickness (single wall) | 250 μm |
|---|---|
| S 100% | 1.2 MPa |
| Elongation at break | 500% |

### EXAMPLE 3

A glove-shaped former was heated to 70° C. for 1 minute and then dipped for 5 seconds into a compounded blend of Perbunan N latex VT Synthomer 99G43 dispersions.

The coated former was dried at 125° C. for 15 minutes and then washed in water at a temperature of 65° C. for 5 minutes to remove excess coagulant. The former was dried at 120° C. until the layer of coagulated substrate was at a temperature of 100° C. The former was then dipped for 10 seconds into the aqueous dispersion of fluoroelastomer given in Example 1.

The former was heated at 115° C. for 20 minutes and then dipped in a cool (15-25° C.) 20% alcoholic solution of calcium nitrate. This dipping is employed to wet the surface of the layer of fluoroelastomer so that it can be coated with a second layer of substrate material. The former was dipped again for 60 seconds into the substrate solution given above and then dried for 20 minutes at 115° C. The finished glove was dusted with talc and stripped from the former. This ‘sandwich’ type glove had the following physical characteristics:

| | | |
|---|---|---|
| Thickness (single wall) | 400 | μm |
| S 100% | 2.88 | MPa |
| Tensile strength | 24.7 | MPa |

Upon testing, the glove in each of the Examples showed good solvent-resistance against a broad range of solvents.

### EXAMPLE 4

It is an important requirement of the close-fitting thin elastomeric gloves of the invention that the solvent-resistance is not reduced upon stretching. It will be appreciated that the gloves are necessarily stretched at donning. We have tested the gloves of Example 2 herein by measuring their resistance, before and after stretching, to permeation by chloroform and toluene. There was no change with chloroform and only a very slight diminution in resistance to toluene. The numerical results are in the Table I below.

The solvent-resistance was determined following the methods described in the European standard for measuring permeation resistance, EN374 part 3:1994. Protective gloves against chemicals and micro-organisms Part 3: Determination of resistance to permeation by chemicals. The resistance of a protective glove material to permeation is determined by measuring the breakthrough time of the chemical through the glove material. In the permeation test apparatus, the glove material partitions the test chemical from the collecting medium. The collecting medium, which can be a gas or a liquid is analysed quantitatively for its concentration of the test chemical and thereby the amount of that chemical that has permeated the barrier as a function of time after initial contact with the glove material. The breakthrough time is deemed to have occurred when the analytical equipment detects as permeation rate of 1 μg/cm²/min. The reported breakthrough time for any particular glove material/chemical combination is the mean of three determinations.

In the present tests for both chloroform and toluene, the collecting medium was nitrogen and the analytical technique used was gas chromatography.

The stretching of the samples was carried out by extending them ten times in one direction to 1.5 times the original unstretched dimension (that is, a 50% elongation), allowing the sample to return to its original dimensions in-between stretches. The samples were then stretched in a direction orthogonal to the first stretching direction, ten times to 1.5 times the original unstretched dimension, allowing the sample to return to its original dimension in-between stretches. The samples were then tested for solvent-resistance.

By way of comparison, thin films were made from a 50/50 blend of an aqueous dispersion of a terpolymer of vinylidene fluoride/hexafluoropropylene/tetrafluoroethylene and an aqueous dispersion of polytetrafluoroethylene. The composition was essentially the same as Fluorobase T300 used in Example 1 except that the proportions of terpolymer and polytetrafluoroethylene were different. The dispersion was compounded as in Example 1 and thin films laid down on the same substrate as in Example 1. The permeabilities of the films, before and after stretching, were then measured. The results were:

TABLE I

| Sample | Elongation | Solvent | Permeation time (m) |
|---|---|---|---|
| Example 2 | — | CHCl₃ | 62 |
| Example 2 | 50% | CHCl₃ | 58 |
| Example 2 | — | toluene | 95 |
| Example 2 | 50% | toluene | 77 |
| Comparison | — | CHCl₃ | 2 |
| Comparison | 50% | CHCl₃ | 4 |
| Comparison | — | toluene | 35 |
| Comparison | 50% | toluene | 9 |

It is expected that the solvent-resistant glove of the invention will exhibit unexpected properties when the fluoroelastomer is provided in percentages of 4%, 5% and 6%.

1. A process for improving the solvent-resistance of a thin, flexible glove comprising a substrate layer and a thin solvent-resistant layer comprising a fluorinated elastomer, comprising
dipping a glove shaped former into a first composition to form a first layer, and removing the former from the first composition; and
dipping the former into a second composition to form a second layer and removing the former from the second composition;
wherein the first composition is a substrate composition and the second composition is an aqueous dispersion of a fluorinated elastomer, containing a fluoroplastic, wherein the fluoroplastic is present and is in an amount of about 5% by solids weight of the dispersion.

2. A process according to claim 1, wherein the glove further comprises a second substrate layer such that the solvent-resistant layer is sandwiched between the first and second substrate layers.

3. A process according to claim 1, wherein the fluorinated elastomer is a copolymer of vinylidene fluoride with one or more of the monomers tetrafluoroethylene, hexafluoropropylene, chlorotrifluoroethylene, 1-hydropentafluoropropylene, and perfluoro(methyl vinyl ether).

4. A process according to claim 1, wherein the fluoroplastic is polyfluoroethylene.

5. A process according to claim 1, wherein the aqueous dispersion comprises, as fluorinated elastomer, a copolymer of vinylidene fluoride, hexafluoropropylene and tetrafluoroethylene, and polytetrafluoroethylene as the fluoroplastic.

6. A process according to claim 1, wherein the aqueous dispersion further comprises a crosslinking agent and an acid-scavenger.

7. A process according to claim 6, wherein the crosslinking agent is a water-soluble or dispersible diamine; a bisphenol; a peroxide; or 1,4-bis(3-aminopropyl)piperazine.

8. A process according to claim 6, wherein the acid-scavenger is a metal oxide.

9. A process according to claim 8, wherein the acid-scavenger is selected from the group consisting of zinc oxide and magnesium oxide.

10. A process according to claim 1, wherein the aqueous dispersion comprises a viscosity modifier.

11. A process according to claim 10, wherein the viscosity modifier is at least one selected from the group consisting of polyvinyl alcohol, polysaccharide gum, acrylic-type thickener and clay.

12. A process according to claim 1, wherein the glove is a thin close-fitting elastomeric glove and the substrate layer is elastomeric.

13. A process according to claim 12, wherein a layer of elastomeric substrate material is coated with a lyer of the fluorinated elsatomeric material.

14. A process according to claim 13, wherein the elastomeric substrate is formed from at least one selected from the group consisting of butyl rubber latex, nitrile latex, polychloroprene latex, a blend of nitrile and polychloroprene latices, natural rubber latex, synthetic polyisoprene latex, polyurethane dispersions/solutions.

15. A process according to claim 14, wherein the elastomeric substrate material is formed from a high acrylonitrile latex or a blend of a high acrylonitrile latex and a nitrile latex.

17. A process for improving the solvent-resistance of a thin, flexible glove comprising a substrate layer and a thin solvent-resistant layer comprising a fluorinated elastomer, comprising
dipping a glove shaped former into a first composition to form a first layer, and removing the former from the first composition; and
dipping the former into a second composition to form a second layer and removing the former from the second composition;
wherein the first composition is a substrate composition and the second composition is an aqueous dispersion of a fluorinated elastomer, containing a fluoroplastic, wherein the fluoroplastic is present and is in an amount of 4% by solids weight of the dispersion.

18. A process for improving the solvent-resistance of a thin, flexible glove comprising a substrate layer and a thin solvent-resistant layer comprising a fluorinated elastomer, comprising
dipping a glove shaped former into a first composition to form a first layer, and removing the former from the first composition; and
dipping the former into a second composition to form a second layer and removing the former from the second composition;
wherein the first composition is a substrate composition and the second composition is an aqueous dispersion of a fluorinated elastomer, containing a fluoroplastic, wherein the fluoroplastic is present and is in an amount of 6% by solids weight of the dispersion.
